(19) United States
(12) Patent Application Publication
(10) Pub. No.: US 2022/0416525 A1
(43) Pub. Date: Dec. 29, 2022

(54) Cable Protection

(71) Applicant: Supergrip (UK) Limited, Birmingham (GB)

(72) Inventors: Darren John Blackburn, Burnley (GB); Gordon Conlon, Newton Aycliffe (GB)

(21) Appl. No.: 17/897,585

(22) Filed: Aug. 29, 2022

Related U.S. Application Data
(63) Continuation of application No. PCT/GB2021/000011, filed on Feb. 8, 2021.

(30) Foreign Application Priority Data
Feb. 27, 2020 (GB) 2002835.3
Dec. 10, 2020 (GB) 2019504.6

(51) Int. Cl. H02G 3/04; F16L 57/02; H02G 3/06; H02G 1/10; F03D 13/10

(52) U.S. Cl. CPC H02G 3/0468; F16L 57/02; H02G 3/0481; H02G 3/06; H02G 1/10; F03D 13/10

(57) ABSTRACT

Protection for a cable, piping or tubing comprises a bend stiffener. This includes at least one element comprising a tubular wall having a substantially smooth inner surface, which defines circumferential recesses along at least part of its length. Each recess has an open end at the circumference of the wall, a base, and sloping sides that are closer to each other at the base than at the open end. Each recess has a depth of no more than 50% of the thickness of the tubular wall. The bend stiffener may include a number of such elements connected together. The cable protection may also include a clamp attached to the bend stiffener.

### CROSS REFERENCE TO RELATED APPLICATIONS

This application is a continuation of PCT Application No. PCT/GB2021/000011, filed 8 Feb. 2021, which claims priority from UK Patent Application No. 20 02 835.3, filed 27 Feb. 2020, and UK Patent Application No. 20 19 504.6, filed 10 Dec. 2020. PCT Application No. PCT/GB2021/000011, UK Patent Application No. 20 02 835.3, and UK Patent Application No. 20 19 504.6 are incorporated herein by reference.

### BACKGROUND OF THE INVENTION

The present invention relates to a bend stiffener for a cable, and a cable protector including such a bend stiffener.

Undersea cables, for example those connected to offshore wind turbines, are generally buried for most of their length. However, sections of the cable, for example at the base of a wind turbine, are in the water above the seabed and require protection. Similar concerns apply to flexible piping and tubing used in other settings.

Bend stiffeners are known, being tubular sheets of flexible plastic that allow a contained cable to bend but add stiffness. These are not generally used to protect long lengths of cable. Instead, bend restrictors are generally used for the span of cable running from the seabed to the base of a wind turbine, in the area known the scour area. These permit bending, but lock out at a minimum radius to prevent the cable from over-bending.

The known way of connecting a cable to the base of a wind turbine is to provide a protector including a latching head and a bend restrictor, through both of which the cable runs freely. The latching head latches to the base of the turbine and the bend restrictor protects the cable in the scour area.

### BRIEF SUMMARY OF THE INVENTION

According to a first aspect of the present invention, there is provided a bend stiffener having a plurality of elements, wherein each said element comprises: a tubular wall having a substantially smooth inner surface; and circumferential recesses defined along at least part of the length of said tubular wall, wherein: each said recess has an open end at the circumference of the wall, a base, and sloping sides that are closer to each other at the base than at said open end, and having a depth of no more than 50% of the thickness of the tubular wall; and each said element has a tubular knuckle at one end of said element and a recess at the other end of said element, wherein the knuckle of a first element fits within the recess of an adjacent element.

In an embodiment, each said element comprises two complementary half-shells configured to be attached together; each said half-shell has two long edges; and each said long edge comprises a cross-section of the tubular wall. The half-shells may be substantially identical.

According to a second aspect of the invention, there is provided a method of protecting a cable or tubing, comprising the steps of: obtaining a first element, formed in two complementary half-shells and comprising a tubular wall having a substantially smooth inner surface, said tubular wall defining circumferential recesses along at least part of its length, and each recess having an open end at the circumference of the wall, a base, and sloping sides that are closer to each other at the base than at the open end, and having a depth of no more than 50% of the thickness of the tubular wall; placing said half-shells around said cable and closing said element; joining said half-shells together, wherein said half-shells are hinged together; placing a second element, substantially similar to said first element, around said cable adjacent to said first element; and attaching said second element to said first element, wherein said first element has a knuckle at one end and said second element has a recess at one end, and said second element is attached to said first element by placing said recess around said knuckle before closing said element.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 illustrates an offshore wind turbine including an electrical cable;

FIG. 2 shows a cable protector used to protect the cable shown in FIG. 1;

FIG. 3 shows a first embodiment of an element that is part of the cable protector shown in FIG. 2;

FIG. 4 is a view of the two half-shells making up the element shown in FIG. 3;

FIG. 5 is a view of the two half-shells shown in FIG. 4 joined together;

FIGS. 6a and 6b illustrate the effect of bending the element shown in FIG. 3;

FIG. 7 illustrates a clamp shown in FIG. 2;

FIG. 8 illustrates a half-shell making up the clamp shown in FIG. 7;

FIGS. 9a, 9b, 9c and 9d illustrate the stages of fitting together pieces to make the cable protector shown in FIG. 2;

FIG. 10 shows a second embodiment of an element that is part of the cable protector shown in FIG. 2;

FIG. 11 is a view of the two half-shells making up the element shown in FIG. 10;

FIG. 12 is a view of the two half-shells shown in FIG. 11 joined together; and

FIG. 13 illustrates an installation vessel installing a cable during the installation of the wind turbine shown in FIG. 1.

### DETAILED DESCRIPTION OF EMBODIMENTS OF THE INVENTION

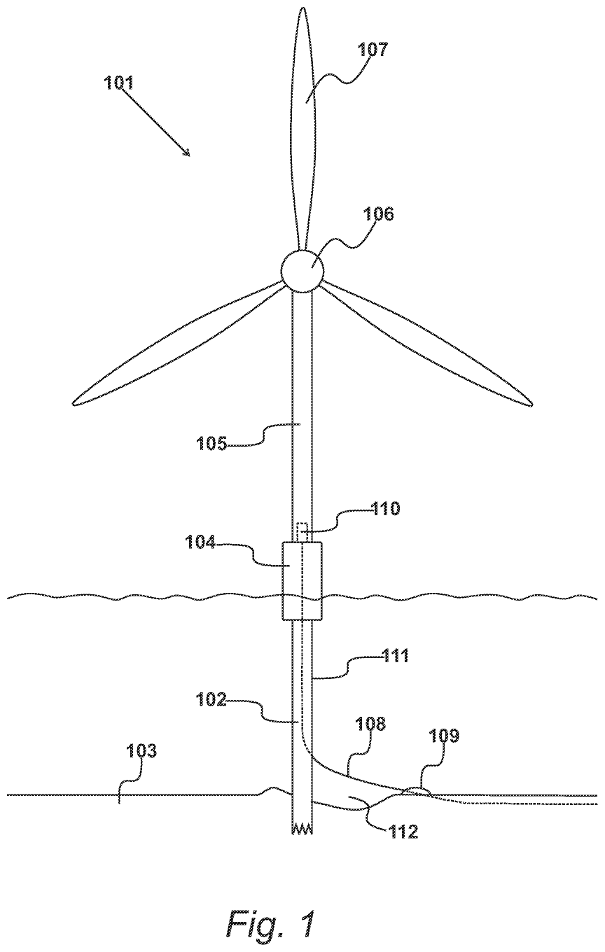

### FIG. 1

A wind turbine 101 is of a type known as a monopile turbine. It comprises a monopile 102 embedded in the seabed 103. A transition piece 104 is attached to the top of monopile 102, and a tower 105 is on top of transition piece 104. Tower 105 comprises the generator 106 and blades 107. The foundation of the monopile descends below the seabed and is not shown here.

Cable 108 connects turbine 101 to the rest of the wind farm, allowing generated energy to be provided to a transformer station. The cable runs under the seabed, exits the seabed under a protective structure 109, passes through the scour area 112, and enters the monopile 102, terminating at a control box 110. Further cabling (not shown) runs through the tower to connect the control box to the generator.

Monopile 102 is a hollow steel tube 5 m in diameter, and the thickness of the wall 111 is 15 cm. Cable 108 passes through an aperture in wall 111. It is not necessary for this aperture to be sealed, as water may enter the monopile. The known method of passing the cable through the aperture is to provide a steel latching head around the cable, which attaches permanently to the apparatus and extends slightly outside it. There are several disadvantages with this method, as follows.

The latching head, being made of steel and having moving parts, may be subject to corrosion and may mechanically fail. Additionally, the steel can cause wear on the cable, particularly since the cable is free to move. (It is necessary for the cable to be free to move because once the latching head is in place, the cable must be pulled up to the top of the monopile.) Next, at the point where the cable exits the latching head it is subject to the current of the sea, and therefore tends to move back and forth with the waves; this creates a potential failure point as the cable may kink where it exits the latching head. Use of a bend restrictor increases the diameter of the cable, meaning that it may move more with the waves. The point where the cable exits the latching head is therefore still a potential failure point.

In the example shown in FIG. 1, the support structure of wind turbine 101 is provided by monopile 102. Other sizes of monopile are suitable for various depths of water. Additionally, many other support structures are known and envisaged for offshore wind turbines, such as tripods, jackets, multi-piles, and so on. Alternatively, the support structure may be a floating structure rather than one with a foundation in the seabed. In all cases, there is a necessity to have a length of cable running from the seabed to the support structure. The cable may then pass inside the support structure, as with the monopile, or may follow it upwards to the tower. In all such cases, there is a necessity for passing the cable either into or around the support structure for connection to the control box, and protecting the cable where it is exposed to sea water and wave action.

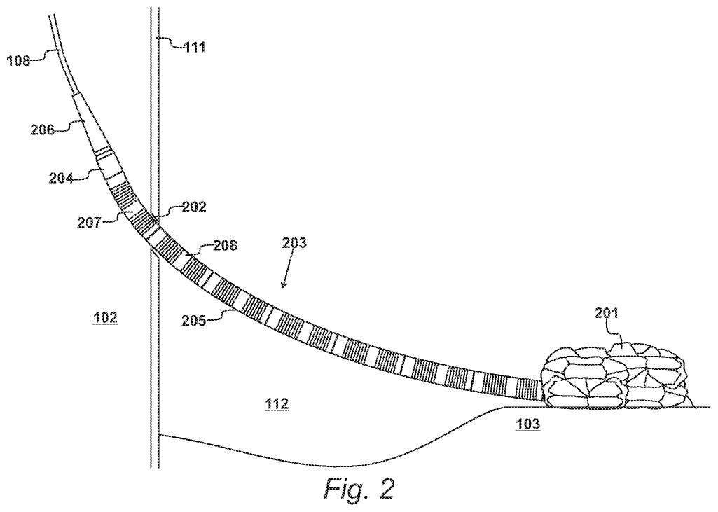

### FIG. 2

FIG. 2 illustrates a portion of monopile wall 111 and the free span of cable 108 in scour area 112. As is typical, the cable is protected from scouring by rocks 201 at the point where it exits seabed 103. There is then a free span of a few metres before the cable enters angled aperture 202 in wall 111. Cable 108 is protected by cable protector 203, which comprises a clamp 204 and bend stiffener 205. A nose bend stiffener 206 is also provided at the front of cable protector 203.

Bend stiffener 205 covers cable 108 from protective rocks 201 to inside monopile 102. Thus, there is no potential failure point caused by kinking, because the entire free span of the cable is protected by a single bend stiffener. This is achieved by clamping clamp 206 to cable 108 and attaching it to bend stiffener 205, before pulling the cable through aperture 202. Because cable protector 203 is not attached to wall 111 of monopile 102, the cable can be pulled through until a sufficient amount of bend stiffener is on the inside of monopile 102, thus preventing any kinking at the point where the cable exits wall 111.

Further advantages of this system are that bend stiffener 205, being made of polyurethane, does not cause wear on aperture 202 in the same way that a steel latching head does, and nor does it cause wear on the cable inside. Cable wear is further reduced by the fact that it is clamped by clamp 206, and thus does not move within cable protector 203. A further advantage of this system is that because the cable protector is not attached to monopile 102, less load is transferred to the monopile during severe weather conditions.

Therefore, cable protector 203, in addition to being significantly cheaper to manufacture because it is made of polyurethane rather than steel and has no moving parts, offers greater reliability than existing systems and therefore should reduce maintenance costs.

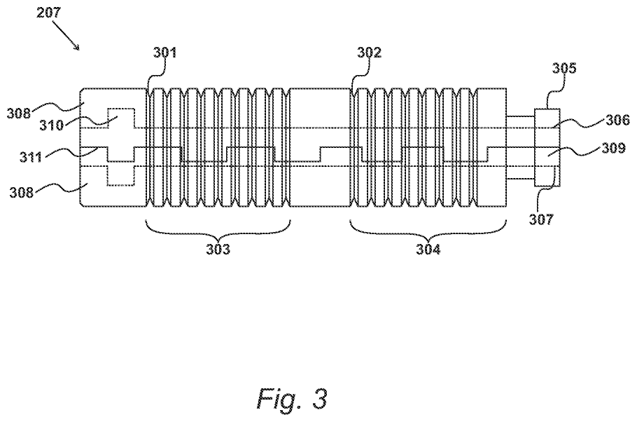

Bend stiffener 205 is made up of a number of identical elements such as elements 207 and 208, which will be described further with respect to FIG. 3. However, in a cable or tubing protection system for a wind turbine having a clamp and bend stiffener, other types of bend stiffener could be used.

### FIG. 3

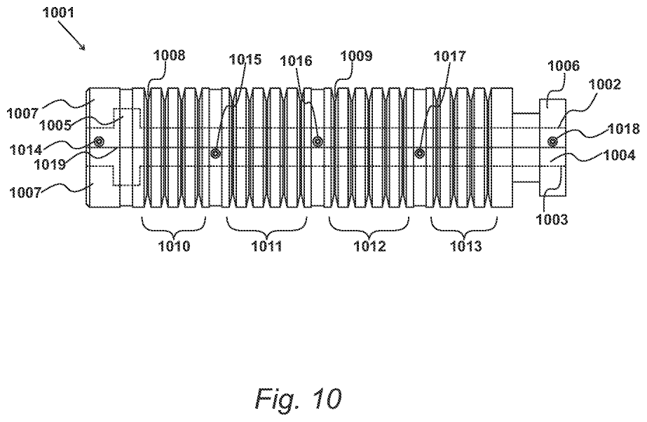

FIG. 3 shows element 207, which in combination with a number of identical elements forms bend stiffener 205. Element 207 is a first embodiment of an element suitable for forming bend stiffener 205, and a second embodiment of a suitable element is shown in FIG. 10.

Element 207 is a circular tube, which in this embodiment is 1 m long, with an external diameter of 28 cm. The internal diameter is 10.5 cm, allowing a snug fit for a cable having a 10 cm diameter. However, other sizes could be used to accommodate different sizes of cable. The length of 1 m minimises the number of elements required to form a bend restrictor without making a single element too unwieldly. However, longer or shorter elements could be used. Dashed lines 306 and 307 indicate the inner surface of the tube, which is smooth and creates an inner void 309, which is substantially cylindrical with an internal recess 310 at one end to allow joining to an adjacent element. Element 207 has an outer and inner circular cross section, as this allows the element to bend equally in all directions. However, if it were desired that the element allowed more bending in one direction than another, the element might have a different shaped cross section. For example, an oval would permit more bending on its long side than on its short side.

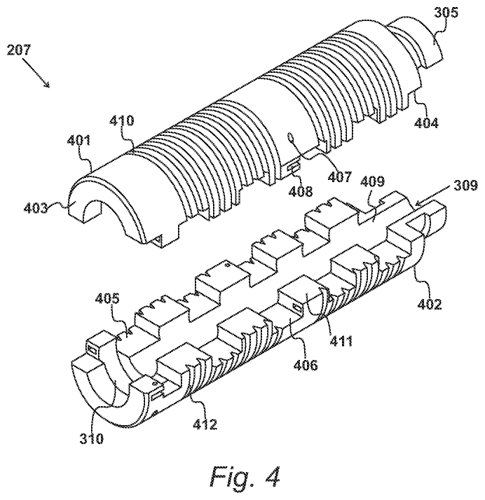

Element 207 has a knuckle 305 at the opposite end from internal recess 310, and joining is achieved by enclosing the knuckle of one element within the internal recess of another element. As will be described further with respect to FIG. 4, element 207 comprises two half-shells with crenelated edges, and line 311 shows the edges of the two half-shells fitted together. The view from the other side of element 207 is almost identical, save that the crenelated joining line is slightly different.

Element 207 is made from polyurethane with a Shore Hardness of 65D; any other suitable material of a suitable hardness could be used.

The tubular wall 308 of the element is 8.75 cm thick along most of its length, except at internal recess 310, and defines circumferential recesses, such as recesses 301 and 302, along its length. In this embodiment, the recesses are grouped into a first set 303 of nine recesses, and a second set 304 of eight recesses. However, any other arrangement could be used. The circumferential recesses provide dynamic bend stiffening along the length of element 207.

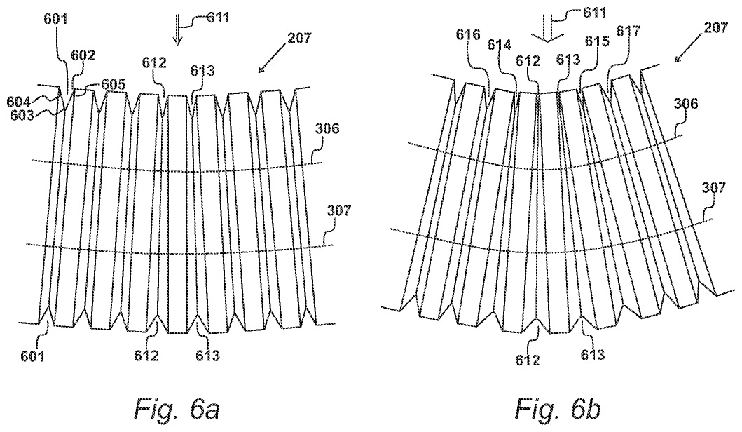

Each circumferential recess such as recess 301 is V-shaped with a slightly curved base. When a force is applied to element 207, it will bend in the direction of the force. On the concave side of the bend the recesses will close up, as shown in FIGS. 6a and 6b, while on the convex side the recesses will open out. This allows bending to take place when a smaller force is applied, compared with a bend stiffener without recesses. However, as the force is increased and the recesses close up further, the element becomes stiffer. In other words, the amount of force required to continue the bend increases with the bending of the element. This provides dynamic bend stiffness, as will be described further with reference to FIGS. 6a and 6b.

In order for this dynamic bend stiffness to be present, the depth of each recess, such as recess 301, should be no more than 50% of the thickness of the tubular wall 308 of the element. In the embodiment of FIG. 3, the depth of each recess is around 20% of the thickness of the wall. Recesses that are deeper than this will tend to allow unrestricted bending rather than dynamic bend stiffness.

The effect of this dynamic bend stiffness is that force applied to one place on the bend stiffener will tend to be spread along the length of the stiffener, thus reducing the likelihood of a single part of the bend stiffener over-bending and causing a kink.

### FIG. 4

Element 207 comprises two substantially identical half-shells 401 and 402 which are bolted together around cable 108. Half-shell 401 comprises a wall 403, on the outside of which are defined recesses such as recess 410. Half-shell 402 comprises a wall 411, on the outside of which are also defined recesses such as recess 412. When joined together, wall 403 and wall 410 form tubular wall 308 of element 207, the recesses match to form circumferential recesses 301, and internal cylindrical void 309 is formed. It can be seen that tubular wall 308 has a smooth inner surface 409; thus, the wall 308 of the element is not corrugated, but defines recesses on its outer surface only.

Each half-shell has two long edges. Long edge 404 of half-shell 401 is visible, and long edges 405 and 406 of half-shell 402 are visible. Each long edge is a cross section through the tubular wall which is complementary to the corresponding wall on the other half-shell.

In this embodiment, the long edges are crenelated, causing them to fit together as can be seen in FIG. 3. The crenelation prevents a single long joining line that could open when the element bends, which could allow particulate matter to enter the bend stiffener and abrade the cable.

Using identical elements minimises the cost of tooling and therefore of manufacture. However, in other embodiments, the half-shells could be hinged together using some form of hinging element, in which case they would be quicker to fit around the cable as the number of bolting points would be reduced; in that case, it might be that only the non-hinged long edges are crenelated.

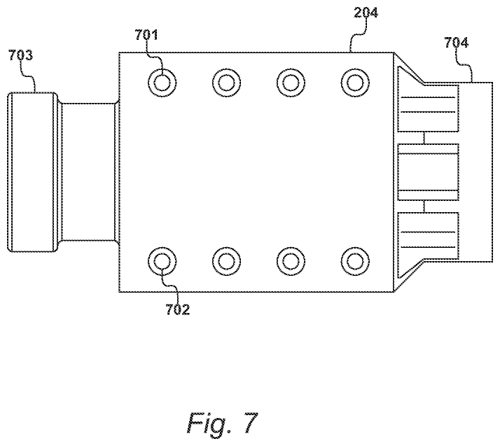

The knuckle 305 of each element is held within an adjacent element. Internal recess 310 of element 207 holds the knuckle of an adjacent element. Additionally, clamp 206 is formed with a knuckle as will be shown in FIG. 7, and therefore the first element in the bend stiffener that is adjacent to the clamp is attached to it by this means. Other attachment means to connect elements together could be used.

Each of the half-shells defines bolt holes such as bolt hole 407 and washer slots such as washer slot 408. To fix two half-shells together a washer is placed in washer slot 408, and a bolt is placed in hole 407 and passed through the washer. It is then self-tapped into the other half-shell. In this embodiment six bolt points are provided. However, other methods of connecting the shells could be used.

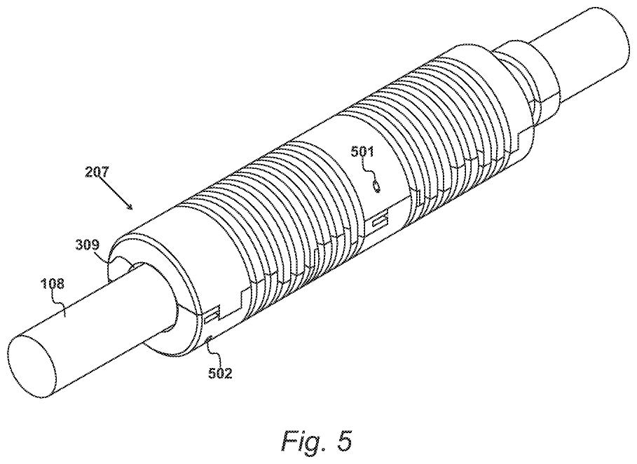

### FIG. 5

FIG. 5 shows element 207 after half-shells 401 and 402 have been placed together and bolted around an example cable 503, which almost fills cylindrical void 309. Bolts 501 and 502 are shown.

Element 207 may be used on its own as shown in this Figure, or with a number of identical elements to form any length of bend stiffener. The embodiment shown herein of the cable protector for an offshore wind turbine is only one example of how it may be used. This dynamic bend stiffener may replace other bend stiffeners and bend restrictors in any suitable setting, for example protection of other undersea electric cables, protection of gas and oil piping and tubing, and so on.

### FIGS. 6a and 6b

As described with reference to FIG. 3, element 207 provides dynamic bend stiffening. This is illustrated in FIGS. 6a and 6b.

Each circumferential recess, such as recess 601, has an open end 602 at the circumference of the tubular wall (the inside diameter of which is shown at dashed lines 306 and 307), and a base 603. The sides 604 and 605 are sloped to form a substantially V-shaped cross-section, so that the sides are closer to each other at the base than at the open end, and base 603 has a curvature.

When element 207 is unbent, the distance between the sides 604 and 605 at the open end is 16.5 mm and the space between adjacent recesses is 23 mm. Each recess is 20.5 mm deep, and the sides slope at an angle of 72° from the horizontal. This shape, size and spacing of the recesses has been determined to work well in an undersea setting for protection of a wind turbine cable. Other shapes, sizes and spacing of recesses may be used to allow more or less bend in the bend stiffener, depending on requirements.

In FIG. 6a, a force 611 has been applied. This causes recesses 612 and 613 to start to close up and allow bending, to create a concave curve on the side on which the force is applied, while on the convex side the same recesses open up slightly. The curvature of the recesses facilitates this opening up.

In FIG. 6b, force 611 is increased. Slot 612 and 613 are now almost entirely closed on the concave side. The effect of the closing of the recesses is that the tubular wall becomes thicker within the recesses. This makes the element more difficult to bend at this point. Thus, the adjacent recesses 614 and 615 also begin to close, because at those points less force is required to bend the element than at recesses 612 and 613. As these also start to close, bending continues at the next adjacent recesses 616 and 617, as again less force is required to bend at these points. Thus, rather than all the force being applied to one point of the bend stiffener, it is spread along its length by the provision of dynamic stiffness.

Eventually, when all the recesses are closed, the bend stiffener will tend to lock out, as the only way it can continue to bend is by deformation of the polyurethane which takes considerably more force. Thus, the effect of the dynamic bend stiffener is to provide dynamic stiffness when smaller forces are applied, but to behave like a bend restrictor under large forces. This means it can replace a bend restrictor without loss of functionality. However, this behaviour will vary by choice of material. A more flexible material will deform to allow further bending after the recesses are closed, whereas a less flexible material will not bend further and will provide bend restriction.

The element can be designed to lock out at an appropriate bend radius. The radius is dependent upon the depth of the recesses relative to the thickness of the wall: deeper recesses will lock out at a smaller radius (i.e., allow more bending). Recesses deeper than around 50% of the thickness of the wall would allow a bend radius approaching zero, and therefore a suitable recess depth would be less than this.

Thus, there is herein described a bend stiffener comprising an element, such as element 207, which comprises a tubular wall, such as wall 308, having a substantially smooth inner surface. The wall defines circumferential recesses, such as recess 301, along at least part of its length, each recess having an open end at the circumference of the wall and a base, and having sides that slope away from the base. The depth of each recess is no more than 50% of the thickness of the wall.

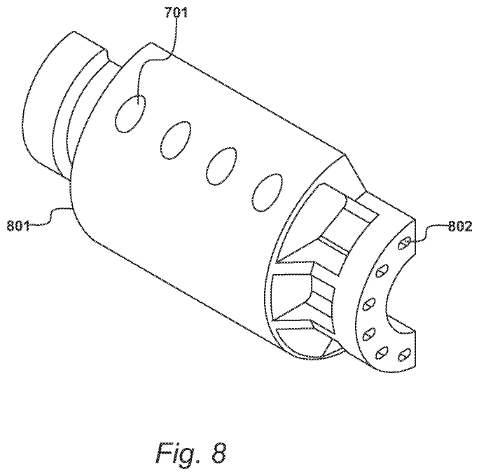

### FIGS. 7 and 8

Clamp 204 is illustrated in FIG. 7. It comprises two half-shells, one of which is shown in FIG. 8 as half-shell 801. The clamp is a substantially cylindrical tube, having an inner diameter the same or slightly smaller than the diameter of cable 108. The two half-shells are placed around cable 108 and bolted together through bolt holes such as holes 701 and 702. These are tightened until the clamp is immovable on the cable.

The clamp includes a knuckle 703 which is identical in size and shape to the knuckle 305 of element 207. In order to attach clamp 204 to a length of bend stiffener elements, a first element is attached around the clamp, such that knuckle 703 fits within a recess, such as recess 310. Other attachment means could be used.

The clamp narrows at its front end 704 in order to attach a nose bend stiffener 206. This is bolted on through holes such as hole 802. The nose bend stiffener serves to prevent the cable kinking where it exits the front of the clamp, but in other embodiments it may be omitted, may be of a different type, or may be attached by other means.

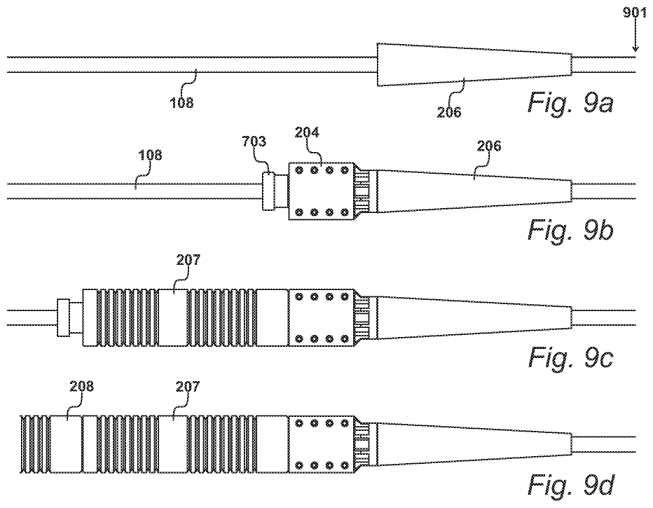

### FIGS. 9a, 913, 9c and 9d

FIGS. 9a to 9d show the stages of construction of cable protector 203. First, as shown in FIG. 9a, cable 108 is threaded through nose bend stiffener 206. This is a conical tube, with the wall thickening from the front to the back. The internal diameter is wider than the diameter of cable 108, to allow the cable to pass freely through it. The nose bend stiffener 206 is positioned at a point in the cable such that there is a predetermined length of cable 901 at the nose end. In the embodiment herein described, this would be approximately the distance from the aperture 202 in monopile 102 to the control box 110.

As shown in FIG. 9b, clamp 204, in two half-shells, is then clamped onto cable 108. Once in position, the front of the clamp is bolted to nose bend stiffener 206. These are now immovably attached to cable 108.

As shown in FIG. 9c, a first bend stiffener element 207 is added. The two half-shells are placed around cable 108 and knuckle 703 of clamp 204, and bolted together. Element 207 is now attached to the back of clamp 204.

As shown in FIG. 9d, a further bend stiffener element 208 is then attached in the same way to element 207. This continues until a desired length of bend stiffener 205 is achieved.

Thus, there is disclosed herein a cable or tubing protector comprising a plurality of connected elements, such as elements 207 and 208. Each has a knuckle held within a recess of an adjacent element. The exception is the two end elements, which have either a recess or a knuckle free. In this embodiment, there is also provided a clamp having a knuckle, held within the recess of an end element.

### FIG. 10

FIG. 10 illustrates a second embodiment of an element suitable for forming bend restrictor 205. Element 1001 is a circular tube, which in this embodiment is 1 m long, with an external diameter of 28 cm. The internal diameter is 10.5 cm, allowing a snug fit for a cable having a 10 cm diameter. However, other sizes could be used to accommodate different sizes of cable. The length of 1 m minimises the number of elements required to form a bend restrictor without making a single element too unwieldly. However, longer or shorter elements could be used. Dashed lines 1002 and 1003 indicate the inner surface of the tube, which is smooth and creates an inner void 1004, which is substantially cylindrical with an internal recess 1005 at one end to allow joining to an adjacent element. Element 1001 has an outer and inner circular cross section, as this allows the element to bend in all directions. However, if it were desired that the element allowed more bending in one direction than another, the element might have a different shaped cross section. For example, an oval would permit more bending on its long side than on its short side.

Element 1001 has a knuckle 1006 at the opposite end from internal recess 1005, and joining is achieved by enclosing the knuckle of one element within the internal recess of another element.

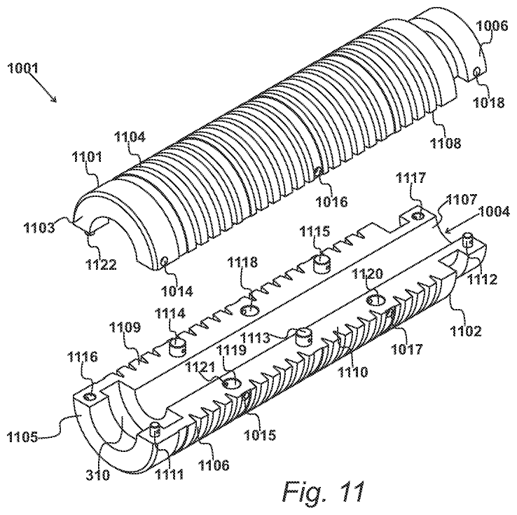

As will be described further with respect to FIG. 11, element 1001 comprises two half-shells. Holes 1014, 1015, 1016, 1017 and 1018 provide fixing points to hold the half-shells together, and line 1019 shows the edges of the two half-shells. The view from the other side of element 1007 is identical.

Element 1001 is made from polyurethane with a Shore Hardness of 56D; any other suitable material of a suitable hardness could be used.

The tubular wall 1007 of the element is 8.75 cm thick along most of its length, except at internal recess 1005, and defines circumferential recesses, such as recesses 1008 and 1009, along its length. In this embodiment, the recesses are grouped into four sets of recesses: first set 1010 of four recesses, second set 1011 of five recesses, third set 1012 of five recesses, and fourth set 1013 of four recesses. The circumferential recesses provide dynamic bend stiffening along the length of element 1001.

This embodiment and the embodiment shown in FIG. 3 differ in their arrangement of recesses. The arrangement may be varied still further, and may be dependent upon the hardness of the material used, the length and width of the element, the thickness of the wall, and the depth of the recesses.

Each circumferential recess such as recess 1008 is V-shaped with a slightly curved base. This curvature is shown more clearly in FIG. 10 than in FIG. 3, but the recesses are substantially similar in both embodiments. When a force is applied to element 1001, it will bend in the direction of the force. On the concave side of the bend the recesses will close up, as shown in FIGS. 6a and 6b, while on the convex side the recesses will open out. This allows bending to take place when a smaller force is applied, compared with a bend stiffener without recesses. However, as the force is increased and the recesses close up further, the element becomes stiffer. In other words, the amount of force required to continue the bend increases with the bending of the element.

In order for this dynamic bend stiffness to be present, the depth of each recess, such as recess 1008, should be no more than 50% of the thickness of the tubular wall 1007 of the element. In the embodiment of FIG. 10, the depth of each recess is around 30% of the thickness of the wall. Recesses that are deeper than this will tend to allow unrestricted bending rather than dynamic bend stiffness.

The effect of this dynamic bend stiffness is that force applied to one place on the bend stiffener will tend to be spread along the length of the stiffener, thus reducing the likelihood of a single part of the bend stiffener over-bending and causing a kink.

### FIG. 11

Element 1001 comprises two substantially identical half-shells 1101 and 1102 which are pinned together around a cable. Half-shell 1101 comprises a wall 1103, on the outside of which are defined recesses such as recess 1104. Half-shell 1102 comprises a wall 1105, on the outside of which are also defined recesses such as recess 1106. When joined together, wall 1103 and wall 1105 form tubular wall 1007 of element 1001, the recesses match to form circumferential recesses such as recess 1008, and internal cylindrical void 1004 is formed. It can be seen that tubular wall 1007 has a smooth inner surface 1107; thus, the wall 1007 of the element is not corrugated, but defines recesses on its outer surface only.

Each half-shell has two long edges. Long edge 1108 of half-shell 1101 is visible, and long edges 1109 and 1110 of half-shell 1102 are visible. Each long edge is a cross section through the tubular wall which is complementary to the corresponding wall on the other half-shell. The half-shells are fixed together by means of complementary projections and depressions along the long edges.

Half-shell 1102 defines a number of cylindrical projections that are upstanding from its long edges. Small projections 1111 and 1112 are at either end of long edge 1110 and large projection 1113 is in roughly the centre, between second and third sets of recesses 1011 and 1012. Large projections 1114 and 1115 are upstanding from long edge 1109, between the first and second sets of recesses 1010 and 1011 and the third and fourth sets of recesses 1012 and 1013 respectively. Each projection defines a hole for a fixing pin, orthogonal to the long axis of the half-shell.

Opposite each projection, the opposing long edge defines a depression of a reciprocal size and shape. Thus, long edge 1109 defines small depressions 1116 and 1117 at either end. and large depression 1118 in roughly the centre, between second and third sets of recesses 1011 and 1012. Similarly, long edge 1110 defines large depressions 1119 and 1120 between the first and second sets of recesses 1010 and 1011 and the third and fourth sets of recesses 1012 and 1013 respectively. In the wall of each half-shell are defined holes, orthogonal to the long axis of the half-shell and lined up with each depression. For example, hole 1015 in half-shell 1102 is lined up with depression 1119. Each hole continues on the other side of the depression, for example hole 1121 is a continuation of hole 1015.

Half-shell 1101 is identical and therefore has identical projections and depressions in its long edges, of which only one can be seen, small projection 1122.

To join half-shells 1101 and 1102, the projections are fitted into their reciprocal depressions on the other half-shell. For example, projection 1122 is fitted into depression 1116. Nylon pins (not shown) are used to hold the half-shells together. For example, a pin is passed through hole 1015, through the hole in the projection, and into continuation hole 1121. The pin is hammered into place, and held by a friction fit. In this example, five pins are fitted on each side. Alternative arrangements of the projections and depressions, and alternatives to the hammered nylon pin (such as a threaded bolt) could be used.

This method of joining the half-shells together, with alternating projections and depressions, and pins in both half-shells, serves the same function as the crenelation of the first embodiment, i.e., preventing the joining line 1019 between the half-shells opening up when element 1001 bends. Such an opening could allow particulate matter to enter the bend stiffener and abrade the cable.

Using identical elements minimises the cost of tooling and therefore of manufacture. However, in other embodiments, the half-shells could be hinged together using some form of hinging element, in which case they would be quicker to fit around the cable as the number of bolting points would be reduced. In that case, it might be that the projections, depressions and holes for pins would only be present on one of the long edges. Thus, two embodiments have been described that use different methods of joining half-shells to form an element. Other suitable joining methods could also be used.

To join two elements together, the knuckle 1006 of each element is held within an adjacent element. Internal recess 1005 of element 1001 holds the knuckle of an adjacent element. Additionally, as with the first embodiment, the first element in the bend stiffener that is adjacent to clamp 204 is attached to it by engaging with knuckle 703. Other attachment means to connect elements together could be used.

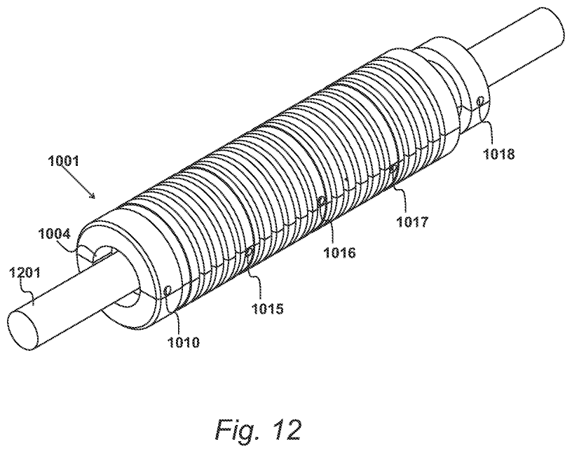

### FIG. 12

FIG. 12 shows element 1001 after half-shells 1101 and 1102 have been placed together around an example cable 1201, which almost fills cylindrical void 1004. Pins have been hammered into the holes 1014 to 1018.

Element 1001 may be used on its own as shown in this Figure, or with a number of identical elements to form any length of bend stiffener, in the same way as shown in FIG. 9. Further, since this embodiment differs from the first embodiment only in the method of fixing the half-shells together and the arrangement of the recesses, the two embodiments (or another embodiment) could be joined together if necessary to form a bend stiffener.

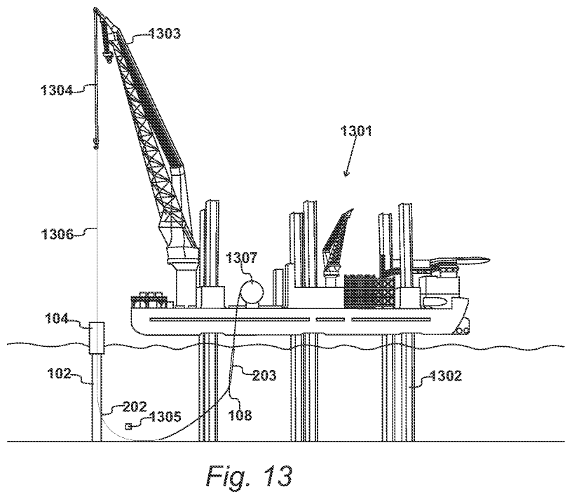

### FIG. 13

Installation of cable 108 in monopile 102 is illustrated in FIG. 13. Typically, such installation is carried out by a self-elevating installation vessel 1301. This is a boat that, after navigating to the required position offshore, elevates itself on a number of legs, such as leg 1302. This ensures that the vessel is kept in position during installation of wind turbines and provides a foundation for the lifting of the heavy components. However, for the installation of cable an anchored boat may be sufficient.

Vessel 1301 has a crane 1303 including a hoist rope 1304. Underwater, the installation is assisted by a remotely operated underwater vehicle (ROV) 1305, which is preferred for reasons of cost and safety to a human diver. This is wirelessly connected to control equipment on board vessel 1301, for control by an operator. It includes a camera to provide an underwater view to the operator.

Before the cable is installed, a messenger wire 1306 is fed through the monopile and out through aperture 202 with the assistance of ROV 1305, and the underwater end is then passed back up to installation vessel 1306.

Cable 108 is held on spool 1307 on vessel 1301. On the vessel, cable protector 203 is installed, leaving a predetermined length of cable 901 ahead of the front end. Either element 207 or element 1001 may be used to form the bend stiffener 205.

Cable 108 is then attached to messenger line 1306 which is attached to hoist rope 1304, so that the cable can be pulled into position using crane 1303. When the end of cable 108 reaches the top of transition piece 104, a visual check is made using ROV 1305 that the clamp 204 and front portion of bend stiffener 205 have entered through aperture 202. The cable is then secured and the messenger wire 1306 disengaged.

The remainder of the cable is then unspooled to the seabed before being buried. Typically, installation vessel 1301 includes a trenching unit or other cable burial equipment.

This method of installing a cable for an offshore wind turbine is simpler than the known methods, in which the cable protection system includes a latching head. In such a method, a check must be made using the ROV that the latching head has installed correctly. Because the cable is pulled along the seabed, the water is often murky and it can be difficult to ascertain this. Once the cable is detached from the latching head and pulled freely through the cable protection system to the top of the monopile, it is not then possible to exert any force on the latching head if it is not in the correct position. Therefore, maintenance can only be achieved using a ROV having manipulator features, or a human diver.

By contrast, using the method described herein, it is only necessary to confirm that at least some of the bend stiffener has entered the aperture, which is considerably easier to ascertain visually in murky water. Further, because cable 108 is permanently attached to cable protector 203, if it later transpires that the cable protector is not in quite the right position it is a simple matter to raise or lower the cable using a crane or winch.

Further advantages with the system described herein relate to maintenance. In all of the known systems, once the latching head is in place it is not designed to be removed. Some systems include removal tools, but these are generally difficult to use and require use of an ROV with manipulator features or a human diver. Therefore, if there is any failure of the protection system, it is a difficult matter to remove it and replace it. However, cable protector 203 includes no metal or moving parts and is therefore unlikely to fail.

Thus, there is described herein a method of installing an electrical cable in an offshore wind turbine having a support structure, which in this example is monopile 202. It comprises the steps of attaching a clamp, which in this example is clamp 204, to the cable, and attaching a bend stiffener, which in this example is bend stiffener 205, to the back end of the clamp such that it surrounds the cable. The cable is passed into the support structure, such that the clamp enters structure front end first, and pulled upwards until it reaches a desired height.

1. A bend stiffener having a plurality of elements, wherein each said element comprises:
a tubular wall having a substantially smooth inner surface; and
circumferential recesses defined along at least part of a length of said tubular wall, wherein:
each said circumferential recess has an open end at a circumference of said tubular wall, a base, and sloping sides that are closer to each other at said base than at said open end, and having a depth of no more than 50% of a thickness of said tubular wall; and
each said element has a tubular knuckle at one end of said element and a recess at the other end of said element, wherein said tubular knuckle of a first element fits within said circumferential recess of an adjacent element.

2. The bend stiffener of claim 1, wherein:
each said element comprises two complementary half-shells configured to be attached together;
each said half-shell has two long edges; and
each said long edge comprises a cross-section of the tubular wall.

3. The bend stiffener of claim 2, wherein said half-shells are substantially identical.

4. A bend stiffener of claim 2, further comprising at least one hinging element connecting adjacent long edges of said half-shells.

5. The bend stiffener of claim 2, wherein for at least one long edge of each of said half-shells, edges are crenelated along at least part of their length, such that said edges interlock when joined together.

6. The bend stiffener of claim 2, wherein:
one half-shell comprises a projection upstanding from one long edge; and
the other half-shell has a reciprocal depression defined in one long edge, such that said projection fits into said depression when said half-shells are placed together along their long edges.

7. The bend stiffener of claim 6, wherein each long edge of each half shell has at least one such projection and at least one such depression, such that said projections and depressions fit together when said half-shells are placed together along their long edges.

8. The bend stiffener of claim 7, wherein:
a first hole is defined through said tubular wall of an element to said depression, for at least one of said depressions;
a second hole is defined in said projection that is reciprocal with said depression; and
said element further comprises a pin, wherein said pin is pushed through said first hole and said second hole to hold said half-shells together.

9. The bend stiffener of claim 1, wherein said tubular wall has a substantially circular cross-section.

10. The bend stiffener of claim 1, wherein each said circumferential recess has a substantially V-shaped cross-section.

11. The bend stiffener of claim 10, wherein said base of each circumferential recess is curved.

12. The bend stiffener of claim 1 arranged around a cable or tubing to protect said cable or tubing, wherein said tubular knuckle of each element, excepting one of said end elements, is held within the circumferential recess of its adjacent element.

13. The bend stiffener of claim 12, further comprising a clamp having a knuckle, wherein said knuckle of said clamp is held within said circumferential recess of one of said end elements.

14. A method of protecting a cable or tubing, comprising the steps of:
obtaining a first element, formed in two complementary half-shells and comprising a tubular wall having a substantially smooth inner surface,
said tubular wall defining circumferential recesses along at least part of its length, and
each circumferential recess having an open end at a circumference of said tubular wall, a base, and sloping sides that are closer to each other at said base than at said open end, and having a depth of no more than 50% of a thickness of said tubular wall;
placing said half-shells around said cable or tubing and closing said first element;
joining said half-shells together, wherein said half-shells are hinged together;
placing a second element, substantially similar to said first element, around said cable or tubing adjacent to said first element; and
attaching said second element to said first element, wherein
said first element has a knuckle at one end and said second element has a recess at one end, and said second element is attached to said first element by placing said recess around said knuckle before closing said second element.

15. The method of claim 14, wherein at least one pair of complementary edges of said half-shells are crenelated along at least part of their length, such that said half-shells interlock when joined together.

16. The method of claim 15, wherein:
one half-shell comprises a projection upstanding from one long edge; and
the other half-shell has a reciprocal depression defined in one long edge;
such that said projection fits into said depression when said half-shells are placed together along their long edges.

17. The method of claim 16, wherein a first hole is defined through said tubular wall of said first element to said depression, and a second hole is defined in said projection, and said step of joining said half-shells comprises pushing a pin through said first hole and said second hole.

18. The method of claim 14, further comprising the step of, before attaching said second element to said first element:
obtaining a clamp having a knuckle at one end; and
clamping said clamp around said cable or tubing;
wherein said step of attaching said second element to said first element further includes the step of placing a recess at an end of said first element around said knuckle of said clamp before closing said first element.

19. The method of claim 14 for protecting an electrical cable forming part of an offshore wind generator, further comprising the steps of:
installing said electrical cable in an offshore wind turbine having a support structure, comprising the steps of:
attaching a clamp to said electrical cable, said clamp having a front end and a back end;
attaching a bend stiffener to said back end of said clamp such that said bend stiffener surrounds said electrical cable;
passing said electrical cable into said support structure, such that said clamp enters said support structure front end first; and
pulling said electrical cable upwards until said electrical cable reaches a desired height in said offshore wind turbine.

20. The method of claim 19, wherein:
said support structure comprises a wall defining an aperture; and
said electrical cable, said clamp and at least part of said bend stiffener are passed through said aperture.
